(19) United States
(12) Patent Application Publication
(10) Pub. No.: US 2011/0237140 A1
(43) Pub. Date: Sep. 29, 2011

(54) Combination grounding rod bridge assembly

(76) Inventor: Eric J. Cerasale, Southington, CT (US)

(21) Appl. No.: 12/661,721

(22) Filed: Mar. 23, 2010

(51) Int. Cl. H01R 11/09

(52) U.S. Cl. 439/797

(57) ABSTRACT

By providing a single housing, component or element incorporating a plurality of passageways or receiving zones formed therein, at least one of which is substantially enlarged an easily assembled bonding bar or grounding bridge is achieved. Each passageway or receiving zone is cooperatively associated with a locking screw or set screw which is configured to enable grounding conductors to be inserted through the passageway/receiving zone and securely mounted therein. In addition, the enlarged passageway or receiving zone is constructed for enabling the upper terminating end of a grounding rod to be inserted therein in cooperative association with the grounding conductor extending from an associated meter box, junction box, electrical outlet box or the like. In this way, all of the requirements for a highly effective intersystem bonding termination are realized and all of the newly enacted code provisions are satisfied.

### TECHNICAL FIELD

This invention relates to electrical connectors, and more particularly, to electrical clamps or connectors constructed for bonding and securely grounding communication systems directly with grounding rods.

### BACKGROUND OF THE INVENTION

In the field of wiring homes and buildings, whether for new construction or for improvements or expansion, substantial development and product improvements have been made. Typically, these improvements are directed to enabling installers to securely and safely mount any desired wiring to any desired location in the most efficient and quickest manner.

In any particular installation or location, various conduits or cables must be interconnected to each other as well as connected to the primary power supply in a suitable power distributing outlet box, junction box, meter box, or other enclosure. In these instances, flexible metal conduit and/or armor or metalclad cables within which the electrical power carrying wires are contained, must be securely mounted to the housing of a junction box or outlet box, or connected to an appropriate solid or rigid metal tubing or conduit.

In addition, in order to assure that the installed conduits or cables and the electrical power carrying wires contained therein are properly and safely installed for operation, power distributing outlet boxes, junction boxes, meter boxes, and other similar enclosures typically incorporate grounding electrode conductors which are interconnected to the power supply and extend from the particular box to a properly installed grounding rod or remote grounded location. In this way, all of the power carrying wires installed in the particular home or building are properly connected to a grounded location.

In 2008, various Articles of the National Electric Code (NEC) were rewritten to define new requirements for Intersystem Bonding Termination. In this regard, requirements for installing a bonding connection point for communication systems were specifically defined. Due to the numerous instances in which homes, electrical systems, electronic equipment, communication equipment, and the like were destroyed or severely damaged by uncontrolled events such as lightning, power surges, etc., the new requirements were established to provide an effective and reliable intersystem bonding termination which should reduce or eliminate the difficulties and damage that has been encountered.

In accordance with the new requirements, the intersystem bonding termination establishes a device which provides a connecting point for communication grounding and bonding systems to the electrical service equipment. In achieving this goal, the intersystem bonding terminations must employ either (1) a set of terminals mounted and electrically connected to the meter enclosure, (2) a bonding bar near the service or meter equipment and closure or close to the raceway for the service conductors, or (3) the installation of a bonding bar near the grounding electrode conductor.

Although these requirements have been in existence for several years, commercially available products which are capable of achieving the desired mounted connections are both limited and expensive. Typically, these prior art products incorporate components which are expensive to manufacture due to tolerance requirements for enabling these components to be secured to the desired grounding rod/grounding electrode conductor. Consequently, a need exists in the industry for the production of effective products, such as bonding bars or grounding bridges, which are capable of being employed to satisfy the requirements for the intersystem bonding termination and are capable of being manufactured inexpensively, while also providing a high quality, highly effective and easily employed product.

Therefore, it is a principal object of the present invention to provide a bonding bar or grounding bridge which is capable of being easily installed in any desired location for being secured to a grounding rod or grounding electrode conductor.

Another object of the present invention is to provide a bonding bar/grounding bridge having the characteristic features described above which is manufactured from easily produced components, thereby achieving a safe, effective, and cost efficient product.

Another object of the present invention is to provide a bonding bar/grounding bridge having the characteristic features described above which virtually eliminates complicated installation techniques and achieves an easily installed product which is capable of being used by individuals having widely varied experiences.

Another object of the present invention is to provide a bonding bar/grounding bridge having the characteristic features described above which enables the entire assembly and mounted engagement to be achieved quickly and easily by a single individual.

Other and more specific objects will in part be obvious and well in part appear hereinafter.

### SUMMARY OF THE INVENTION

By employing the present invention, all of the difficulties and drawbacks of prior art systems have been eliminated and an efficient, easily manufactured and easily assembled bonding bar or grounding bridge is achieved. In accordance with the present invention, a single housing, component or element is constructed incorporating a plurality of passageways or receiving zones formed therein, at least one of which is substantially enlarged from the adjacent receiving zones. In addition, each passageway or receiving zone is cooperatively associated with a locking screw or set screw which is configured to enable grounding conductors to be inserted through the passageway/receiving zone and securely mounted therein.

Typically, grounding conductors from telephones, cable televisions, satellite receivers, radios, television antennas, and the like are inserted into the passageways/receiving zones and securely mounted in the desired position. In addition, the enlarged passageway or receiving zone is constructed for enabling the upper terminating end of a grounding rod to be inserted therein in cooperative association with the grounding conductor extending from an associated meter box, junction box, electrical outlet box or the like.

In this way, all of the requirements for a highly effective intersystem bonding termination are realized and all of the newly enacted code provisions are satisfied. Furthermore, the present invention achieves a combination grounding rod bridge assembly which effectively provides the desired bonding of the electrical system in a building or house with the grounding conductors from telephones, cable television, satellite receivers, radios, television antennas, satellite dishes, and the like.

In the preferred construction, the combination grounding rod bridge of the present invention is constructed as a separate and independent housing or element incorporating a plurality of separate and independent passageways or receiving zones formed therein, with each passageway or receiving zone incorporating a separate set screw or locking screw threadedly mounted to the housing. In this regard, each locking screw or set screw is positioned for enabling a grounding conductor to be telescopically inserted into a passageway/receiving zone, with the set screw, locking screw being quickly and easily threadedly advanced for contacting and securing the grounding conductor to the combination grounding rod bridge assembly.

Although the combination grounding rod bridge assembly of the present invention may incorporate any desired number of passageways or receiving zones for enabling a wide variety of various communication systems to be mounted therewith, typically, the combination grounding rod bridge assembly incorporates between about four and six passageways or receiving zones, in addition to the enlarged passageway/receiving zone for being mounted directly to the grounding rod. In this way, conventional installations of various communication systems can be easily accommodated in their entirety.

In addition, in the preferred construction, the combination grounding rod bridge assembly of the present invention is constructed from conductive material in order to assure that the desired grounded and bonding connection is realized and an intersystem bonding termination is achieved.

The invention accordingly comprises an article of manufacture possessing the features, properties, and the relation of elements which will be exemplified in the article hereinafter described, and the scope of the invention will be indicated in the claims.

### THE DRAWINGS

For a fuller understanding of the present invention, reference should be had to the following detailed description taken in connection with the accompanying drawings, in which:

FIG. 1 is a perspective view of the combination grounding rod bridge assembly of the present invention;

FIG. 2 is a top plan view of the combination grounding rod bridge assembly of FIG. 1;

FIG. 3 is a side elevation view of the combination grounding rod bridge assembly of FIG. 1;

FIG. 4 is a front plan view of the combination grounding rod bridge assembly of FIG. 1;

FIG. 5 is a cross-sectional front view of the combination grounding rod bridge assembly taken along the line 5-5 of FIG. 2;

FIG. 6 is a front plan view of an alternate embodiment of the combination grounding rod bridge assembly of the present invention; and

FIG. 7 is a perspective view of the combination grounding rod bridge assembly of the present invention shown installed in position mounted to a grounding rod.

### DETAILED DISCLOSURE

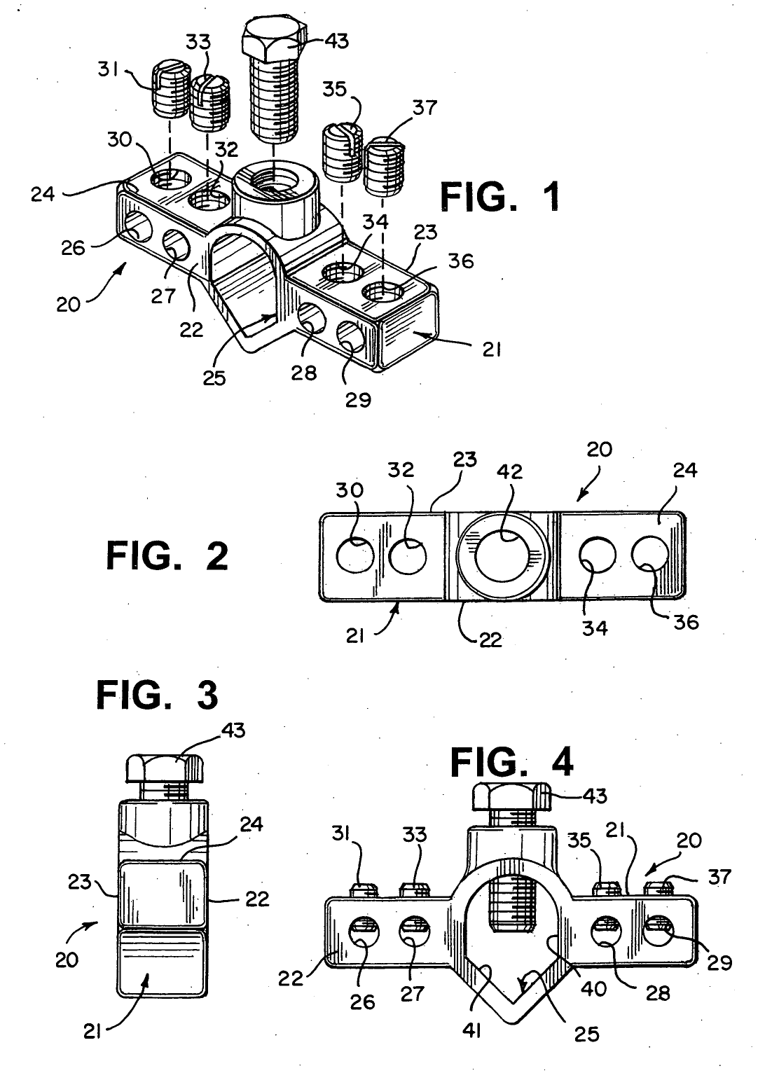

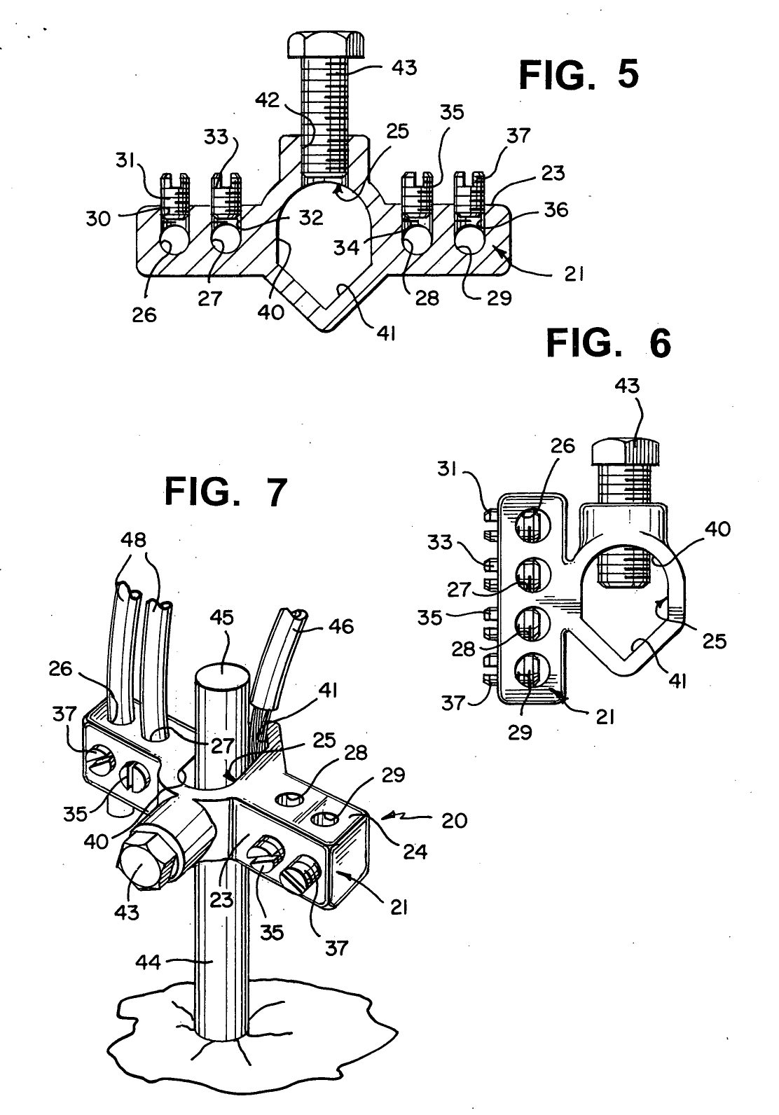

By referring to FIGS. 1-7, along with the following detailed discussion, the construction, operation, and installation of the combination grounding rod bridge assembly of the present invention can best be understood. In addition, in this disclosure, two alternate embodiments of the present invention are fully shown and described. However, further alternate embodiments of the present invention can be implemented without departing from the scope of this invention. Consequently, it should be understood that the following detailed description, as well as the drawings associated herewith, are provided for exemplary purposes and are not intended as a limitation of the present invention.

By referring to FIGS. 1-5, along with the following detailed discussion, the construction of one preferred embodiment of combination grounding rod bridge assembly 20 of the present invention can best be understood. As depicted, in this embodiment, combination grounding rod bridge assembly 20 comprises a generally rectangular shaped, elongated housing or member 21 comprising front surface 22, rear surface 23, and top surface 24. In addition, housing/member 21 incorporates enlarged passageway or channel 25, and smaller, generally circular shaped passageways or channels 26, 27, 28, and 29, each of which are formed adjacent to each other as well as being adjacent to enlarged aperture 22. In the preferred construction, each passageway 25, 26, 27, 28, and 29 are formed in front surface 22 of grounding rod bridge assembly 20, and extend through housing/member 21, terminating at rear surface 23.

In addition, combination grounding rod bridge assembly 20 also incorporates a plurality of screw receiving cavities formed therein, with each screw receiving cavity being associated with one passageway or channel. As depicted, screw receiving cavity 30 is formed in top surface 24 of housing/member 21 in association with passageway/channel 23. In this regard, screw receiving cavity 30 extends into housing/member 21 from top surface 24, terminating in mating communication with passageway/channel 23.

In addition, screw receiving cavity 30 comprises threads formed on the inside surface thereof, thereby enabling cooperating set screw 31 to be inserted therein for threaded engagement therewith. Once set screw 31 has been threadedly engaged in cavity 30, any desired grounding wire or conductor can be easily inserted into passageway/channel 26 and secured in position by advancing set screw 31 in cavity 30 until secure engagement of the grounding wire/conductor is achieved. Whenever grounding wire/conductor is mounted in this position and secured in place, the desired assembly is achieved.

Using virtually identical constructions, cavity 32 is formed in combination grounding rod bridge assembly 20 communicating with passageway/channel 27. In addition, set screw 33 is employed for being threadedly engaged with cavity 32 for securing an additional grounding wire/conductor and the desired position.

Similarly, cavity 34 is mounted in combination grounding rod bridge assembly 20 in communication with channel/passageway 28, while cavity 36 is similarly mounted communicating with passageway/channel 29. Furthermore, set screw 35 is threadedly mounted in cavity 34, while set screw 37 is threadedly mounted in cavity 36 in the identical manner as detailed above for providing additional mounting positions for securing any desired additional grounding wire/conductors.

As is evident from the foregoing detailed disclosure, this embodiment of combination grounding rod bridge assembly 20 provides four separate and independent connection points for enabling for grounding wire/conductors of various communication systems to be securely mounted to grounding rod bridge assembly 20 to achieve the desired intersystem bonding termination for these components. As is evident from this disclosure, combination grounding rod bridge assembly 20 may be constructed with any desired number of connection points for enabling grounding wire/conductors to be secured thereto. In this way, an intersystem bonding termination can be achieved for all of the communication systems installed in a particular location.

As shown throughout the Figures, combination grounding rod bridge assembly 20 also comprises screw receiving, threaded aperture or cavity 42 formed therein in association with passageway/channel 25. In this regard, screw receiving cavity 42 extends into housing/member 21 from top surface 24, terminating in mating communication with passageway/channel 25.

In addition, combination grounding rod bridge assembly 20 also incorporates mounting screw 43 which is constructed for threaded engagement in threaded aperture 42. As a result, once mounting screw 43 is threadedly engaged in aperture 42, mounting screw 43 is able to be arcuately rotated for being advanced into passageways/channel 25 to securely affix combination grounding rod bridge assembly 20 in the desired position.

In this regard, combination grounding rod bridge assembly 20 is constructed for being quickly and easily securely affixed to any desired grounding rod in combination with the grounding electrode or conductor from an associated meter box, junction box, electrical outlet box, and the like. In order to provide grounding rod bridge assembly 20 with this capability, grounding rod bridge assembly 20 incorporates a uniquely constructed passageway/channel 25. As a result, passageway/channel 25 comprises an enlarged configuration which is formed by an articulately curved, generally U-shaped wall portion 40 in combination with a generally V-shaped portion 41. By employing this configuration, grounding rod bridge assembly 20 is quickly and easily securely affixed to any desired grounding rod in combination with the grounding electrode or conductor extending from an associated meter box, junction box, electrical outlet box, and the like.

By referring to FIG. 7, along with the following detailed discussion, the preferred construction of passageway 25 of combination grounding rod bridge assembly 20 can best be understood, as well as the ability of combination grounding rod bridge assembly 20 to be quickly installed in the desired manner. As shown, grounding rod 44 is securely implanted in the ground to the required depth in order to achieve the grounding function, with upper or proximal end 45 extending out of the ground.

In order to quickly and easily achieve the desired installation, combination grounding rod bridge assembly 20 is mounted to grounding rod 44 by telescopically advancing upper/proximal end 45 of grounding rod 44 through passageway/channel 25. Preferably, mounting screw 43 is rotated to enable passageway/channel 25 to be substantially open in its entirety, thereby enabling grounding rod 44 to be positioned, in passageway/channel 25 with grounding rod 44 contacting U-shaped portion 40 of passageway/channel 25.

Once this position has been achieved, grounding conductor 46, which extends from an associated meter box, junction box, electrical outlet box, or the like, is positioned in passageway/channel 25 between grounding rod 44 and V-shaped portion 41. When grounding conductor 46 is in the desired position, mounting screw 43 is advanced into threaded cavity/aperture 42 until combination grounding rod bridge assembly 20 is securely mounted to grounding rod 44 with grounding conductor 46 integrally affixed therewith.

In this way, grounding conductors 48 from telephone, cable television, satellite receivers, radios, television antennas, satellite dishes, and the like can be quickly and easily mounted in any desired passageway/channel 26, 27, 28, and/or 29 in order to complete the entire installation. Once all connections have been securely made, combination grounding rod bridge assembly 20 is completely installed in the desired intersystem bonding termination is realized.

As is evident from the foregoing detailed discussion, the construction of combination grounding rod bridge assembly 20 enables any desired grounding conductors from various communication systems to be quickly and easily installed in a manner which achieves all of the requirements for providing a highly effective intersystem bonding between power and communication grounding systems. In this way, all of the requirements for an intersystem bonding termination are achieved.

In addition to the embodiment of combination grounding rod bridge assembly 20 detailed above, FIG. 6 depicts an alternate embodiment for grounding rod bridge assembly 20. In this embodiment, an alternate configuration is provided while still achieving all of the goals, objectives, and installation ease detailed above.

As is evident from the review of FIG. 6, in this alternate embodiment, combination grounding rod bridge assembly 20 comprises housing/member 21 which is constructed in a manner similar to the embodiment detailed above. As a result, identical components depicted in FIG. 6 use the identical reference numerals. In order to eliminate repetition and unnecessary discussions, the disclosure provided above regarding these virtually identical components is hereby repeated by reference.

As shown, in this embodiment, combination grounding rod bridge assembly 20 incorporates a plurality of circular shaped passageway/channels 26, 27, 28, and 29, each of which are mounted to housing/member 21 in a directly adjacent, side to side relationship. In addition, enlarged passageway/channel 25 is formed in housing/member 21 in an offset position which is interconnected with and spaced away from circular shaped channel/passageways 26, 27, 28 and 29.

By employing this construction, a compact configuration is achieved which is particularly useful in installations where available space is limited. However, although the configuration is distinguishable, the installation ease and operational efficacy remains identical.

As with the embodiment detailed above, enlarged passageway/channel 25 comprises U-shaped portion 40 in combination with V-shaped portion 41. By employing this construction, combination grounding bridge assembly 20 is quickly and easily mounted in secure engagement with grounding rod 44 and grounding conductor 46, with both components being securely positioned in receiving areas for providing trouble-free mounted engagement thereof.

It will thus be seen that the objects set forth above, among those made apparent from the preceding description, are efficiently attained and, since certain changes may be made in the above article without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Having described my invention, what I claim as new and desire to secure by Letters Patent is:

1. A combination grounding rod bridge assembly constructed for being mounted to a grounding rod in combination with an electrical grounding conductor, said grounding rod bridge assembly comprising:
A) a unitary housing/member comprising a compact configuration formed from electrically conductive material,
B) a plurality of passageways/channels formed in the unitary housing/member, with each passageway/channel being constructed for receiving and holding a grounding wire/conductor associated with a communication system component;
C) a plurality of threaded apertures formed in the unitary housing/member with each threaded aperture being in cooperating association with one of said passageways/channels and constructed for receiving a threaded set screw for enabling said set screw to be advanced into securing engagement with a grounding wire/conductor inserted in said passageway/channel; and
D) an enlarged passageway/channel formed in said unitary housing/member and dimensioned for being quickly and easily mountable to a grounding rod and an associated electrical grounding conductor for enabling said grounding rod bridge assembly to be securely affixed thereto in combination with the plurality of grounding wire/conductors associated with various communication system components, wherein said enlarged passageway/channel is further defined as comprising a generally U-shaped wall portion in combination with a generally V-shaped wall portion, thereby providing a configuration which enables the combination grounding rod bridge assembly to be quickly and easily securely mounted to a grounding rod with the electrical grounding conductor directly mounted therewith, with both components being securely sandwiched and peripherally surrounded by the wall portions forming the enlarged passageway/channel;
whereby an intersystem bonding termination is achieved quickly and conveniently.

2. The combination grounding rod bridge assembly defined in claim 1, wherein said assembly further comprises a mounting screw threadedly engaged in the housing/member in cooperating association with the enlarged passageway/channel for enabling the grounding rod bridge assembly to be quickly and easily securely affixed to a preinstalled grounding rod in combination with the electrical grounding conductor extending from a house or building.

3. (canceled)

4. The combination grounding rod bridge assembly defined in claim 2, wherein the mounting screw threadedly engaged in the housing/member in cooperating association with the enlarged passageway/channel is further defined as being constructed for longitudinal advancement into the enlarged passageway/channel for contacting the combined grounding rod and electrical grounding conductor and securely affixing the grounding rod bridge assembly directly therewith.

5. The combination grounding rod bridge assembly defined in claim 2, wherein each of the plurality of passageways/channels is further defined as extending through the housing/member from a front surface to a rear surface thereof.

6. The combination grounding rod bridge assembly defined in claim 5, wherein each of the plurality of passageways/channels is further defined as comprising a generally circular shaped cross-section.

7. The combination grounding rod bridge assembly defined in claim 5, wherein each of the plurality of passageways/channels is further defined as being positioned in the unitary housing/member in a generally continuous, side to side, co-axial array.

8. The combination grounding rod bridge assembly defined in claim 7, wherein the enlarged passageway/channel is further defined as being positioned in the co-axial array of the plurality of passageways/channels for being located in side to side, adjacent relationship to two of the plurality of passageways/channels.

9. The combination grounding rod bridge assembly defined in claim 7, wherein the enlarged passageway/channel is further defined as being positioned directly adjacent in the co-axial array of the plurality of passageways/channels for being located in an offset, adjacent relationship to said plurality of passageways/channels.

10. The combination grounding rod bridge assembly defined in claim 2, wherein the communication system components with which the grounding wires/conductors are associated are further defined as comprising one or more selected from the group consisting of telephones, cable televisions, satellite receivers, radios, television antennas, and satellite dishes.

11. The combination grounding rod bridge assembly defined in claim 2, wherein the electrical grounding conductor associated with the grounding rod is further defined as extending from one selected from the group consisting of meter boxes, junction boxes, and electrical outlet boxes.
